(19) United States
(12) Patent Application Publication
(10) Pub. No.: US 2016/0183716 A1
(43) Pub. Date: Jun. 30, 2016

(54) Mixed Beverage Maker

(71) Applicant: Sunbeam Products, Inc., Boca Raton, FL (US)

(72) Inventors: John Harrington, Boca Raton, FL (US); David Ertur, Boca Raton, FL (US); Asoka Veeravagu, Boynton Beach, FL (US); Alexander Tee, Somerville, MA (US); Evan Gant, Somerville, MA (US); Alexander Denniston, Falmouth, ME (US)

(73) Assignee: Sunbeam Products, Inc., Boca Raton, FL (US)

(21) Appl. No.: 15/060,906

(22) Filed: Mar. 4, 2016

Related U.S. Application Data
(63) Continuation-in-part of application No. 13/980,976, filed on Aug. 20, 2013.
(60) Provisional application No. 62/128,748, filed on Mar. 5, 2015.
(60) Provisional application No. 61/500,251, filed on Jun. 23, 2011.

(51) Int. Cl. A47J 31/44; B01F 15/00; B01F 7/16; B01F 15/02

(52) U.S. Cl. CPC A47J 31/4403; B01F 15/0222; B01F 15/0243; B01F 15/00123; B01F 7/16

(57) ABSTRACT

A mixed beverage maker having an ice-shaving unit combined with a mixing unit. The mixed beverage maker further includes a concentrate container holder in fluid communication with a reservoir. The ice-shaving unit, mixing unit, concentrate container holder and reservoir are operable connect to a controller, which can be programmed to selective control the operational cycles of each of the units, a pumping cycle, a ice shaving cycle, and a mixing cycle. The controller includes at least one preprogrammed routine to control the operational parameters of the pumping cycle, an ice shaving cycle, and a mixing cycle to make the mixed drink.

### CROSS-REFERENCE TO RELATED APPLICATION

The present invention is a Continuation-in-part of U.S. application Ser. No. 13/980,976 entitled Mixed Beverage Maker, filed on Aug. 30, 2013, which is a National Stage filing Application No. PCT/US2012/043735 entitled Mixed Beverage Maker, filed on Jun. 22, 2012, and which claims priority to U.S. Provisional Application No. 61/500,251 entitled Blended Beverage Maker, filed on Jun. 23, 2011, and the present application also claims priority to U.S. Provisional Application No. 62/128,748 entitled Mixed Beverage Maker, filed on Mar. 5, 2015, the contents of all of which are herein incorporated by reference in their entirety.

### FIELD OF THE INVENTION

The present disclosure relates to apparatus for preparing mixed beverages, such as frozen beverages, that consist of finely-divided ice, flavoring, and other ingredients.

### BACKGROUND OF THE INVENTION

The popularity of “frozen beverages” has been increasing dramatically. Frozen drinks typically consist of a mixture of flavorings, fruits, and/or other ingredients and a finely-divided ice/water mixture that has the consistency of a thin paste. This type of drink is often called a “slush” drink because the consistency of the drink resembles its namesake in both viscosity and texture.

A frozen drink can be made by placing the ingredients of the drink, including ice in the form of cubes or crushed ice, in a blender. The blender is operated to mix the ingredients and reduce the ice to a finely-divided state. The mixture is then transferred to a drinking glass for consumption.

Alternatively, frozen drink makers as disclosed in U.S. Pat. No. 4,681,030 can be utilized. The '030 patent recites an apparatus for preparing frozen drinks having an ice-shaving machine combined with a blender. The ace-shaver and blender of the '030 patent are electrically wired together, and programmed to selective control of the periods of time over which the ice-shaver and blender operate. By the momentary activation of a single switch button, the apparatus may be activated and will automatically deliver the appropriate amount of ice to the blender cup and will turn on the blender at the appropriate time and for the appropriate amount of time.

### SUMMARY OF THE INVENTION

The present disclosure provides a mixed beverage maker having an ice-shaving unit combined with a mixing unit. The mixed beverage maker further includes a concentrate container holder in fluid in communication with a reservoir. The ice-shaving unit, mixing unit, concentrate container holder and reservoir are operable connected to a controller. The controller can be programmed to selectively control the operational cycles of each of the units, the pumping cycle, the ice shaving cycle, and the mixing cycle.

The mixing unit includes mixer drive motor positioned in the base. A mixing container can be removably positioned on the mixing unit, where the drive motor engages a mixing element in the mixing container. The ice shaving unit includes a refillable ice container which delivers shaved ice to the mixing container through an ice chute.

The reservoir is removable positioned in the housing, and included a pump. The pump provides a fluid communication between the reservoir and the concentrate container holder.

The concentrate container holder includes a chamber that is sized to receive a concentrate container. A base surface of the chamber may include fluid output passing there through, forming an output nozzle positioned adjacent to the ice chute, above the mixing container. The concentrate container holder also includes a moveably lid, moveable between an open position and a closed position. In the open position, a concentrate container can be positioned in or removed from the chamber. In the closed position, the concentrate container is sealed within the chamber and is pierced, forming a fluid path there though.

The concentrate container is in the form of sealed, impermeable container, containing a drink concentrate. The drink concentrate can take the form of a liquid or powder concentrate. The drink concentrate is a flavored concentrate, and can further, optionally, include nutritional elements such as vitamins, protein, mineral, and the like.

The operation the mixed beverage unit is controlled by the controller, and may including a processor and memory. The controller can be preprogrammed to control the individual cycles of the units; the pump cycle, the ice shaving cycle, and the blending cycle. The controller can be programmed to operate the cycles sequentially, in an overlapping sequential manner, or in combinations.

In operation, the mixing container is positioned on the mixing unit, the drive motor engaging the mixing element. Ice is loaded into the ice shaving unit. The fluid reservoir is filed with a fluid, such as water. However, it is contemplated the juice or there drink fluid can be placed in the reservoir. The concentrate container is positioned, and sealed in the container holder. The sealing of the concentrate container in the container holder creates a fluid path through the concentrate container. The mixed beverage unit is now ready for operation.

To initiate, the start button is depressed, activating the controller. The controller controls the units operation performing the following cycles; pumping cycle, ices shaving cycle, and mixing cycle. The controller can be programmed to operate the cycles sequentially, in an overlapping sequential manner, or in combinations.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a mixed beverage maker of the present disclosure;

FIG. 2 depicts a sectional view of the mixed beverage maker of FIG. 1;

FIG. 3 depicts a container holder of the mixed beverage maker in an open position with concentrate container insertion;

FIG. 4 depicts a container holder of the mixed beverage maker in an open position with concentrate container removal;

FIG. 5 depicts a concentrate container of the present disclosure;

FIG. 6 depicts a sectional view of the mixed beverage maker of FIG. 1 in a ready configuration;

FIG. 7 depicts a sectional view of the mixed beverage maker of FIG. 1 during the pumping cycle;

FIG. 8 depicts a sectional view of the mixed beverage maker of FIG. 1 during the ice shaving cycle;

FIG. 9 depicts a sectional view of the mixed beverage maker of FIG. 1 during the mixing cycle;

FIG. 10 depicts a sectional view of the mixed beverage maker of FIG. 1 at completion of cycles;

FIG. 11 depicts an alternative mixed beverage maker of the present disclosure;

FIG. 12 depicts the mixed beverage maker of FIG. 11;

FIG. 13 depicts a mixing/drinking container for use in the mixed beverage maker of the present disclosure;

FIG. 14 depict a sectional view of the mixing/drinking container of FIG. 13;

FIG. 15 depicts the mixed beverage maker of FIG. 11 in an open position;

FIG. 16 depicts the mixed beverage maker of FIG. 11 in an open position;

FIG. 17 depicts a front isometric view of the rotatable cover of the mixed beverage maker of FIG. 11;

FIG. 18 depicts a rear isometric view of the rotatable cover of the mixed beverage maker of FIG. 11;

FIG. 19 depicts a top is metric view of a container for used in the mixed beverage maker of FIG. 11;

FIG. 20 depicts a bottom is metric view of a container for used in the mixed beverage maker of FIG. 11

FIG. 21 depicts the mixed beverage maker of FIG. 11 including a removable fitment;

FIG. 22 depicts a front of the removable fitment; and

FIG. 23 depict a side view of the removable fitment.

### DETAILED DESCRIPTION OF THE INVENTION

The present disclosure provides a mixed beverage maker having an ice-shaving unit combined with a mixing unit. The mixed beverage maker further includes a concentrate container holder in fluid communication with a reservoir. The ice-shaving unit, mixing unit, concentrate container holder and reservoir are operable connect to a controller, which can be programmed to selective control the operational cycles of each of the units.

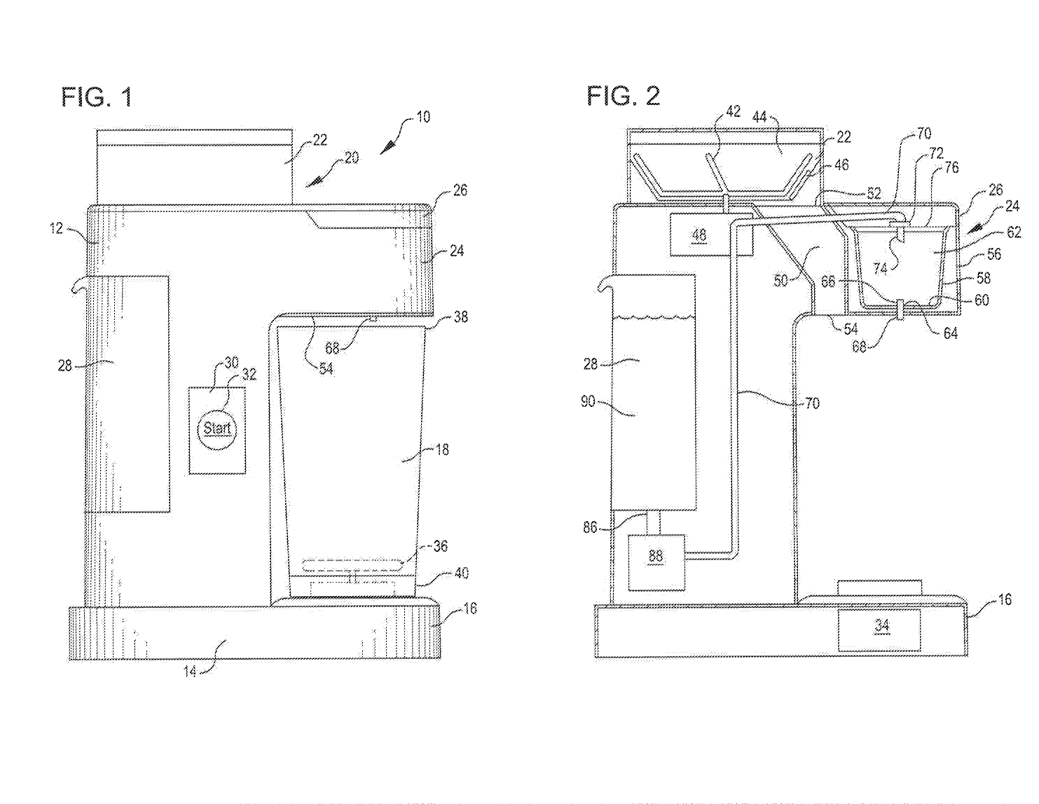

Referring to FIG. 1, the mixed beverage maker 10 includes a housing 12 vertically connected to a base 14. The base 14 has a mixing unit 16 on which a mixing container 18 can be removably positioned. The housing 12 is vertically positioned on the base 14, and includes an ice shaving unit 20 with a refillable ice container 22. A concentrate container holder 24 with a movable lid 26 is positioned adjacent to the ice shaving unit 22, and is in fluid communication with a reservoir 28.

A control panel 30 is provided on the housing 12 and includes at least one switch 32. The mixed beverage maker 10 can include a controller, including a processor and memory, configured and programmed to control the operation thereof. A power supply is connected to the mixed beverage maker 10.

Referring to FIG. 2, the mixing unit 16 includes mixer drive motor 34 positioned in the base 14 of the housing 12. The mixer drive motor 34 can be a single direction motor for rotating a mixing element 36 in the mixing container 18. Alternatively, the mixer drive motor 34 can be a bi-directional drive motor, to selectively rotate the mixing element 36 in the mixing container 18 in either the clockwise or counter-clock wise direction in accordance with a preprogrammed mixing routine.

The mixing container 18 is removably positionably on the mixing unit 16. The mixing container 18 includes an open top end 38 and a bottom end 40 having the mixing element 36. The mixing element 36 can take the form of a whisk mixer, blender blades, mixing paddles, or other mixing element.

When the mixing container 18 is positioned on the mixing unit 16, the mixing element 36 is operably connected to the mixer drive motor 34. The operably connection of the mixing container 18 to the mixing unit 16 can be a physical connection, as used in standard blenders, or a magnetic connection an disclosed in U.S. Pat. No. 6,095,677 entitled Magnetic Drive Blender, the contents of which are incorporated by reference in its entirety.

The ice shaving unit 20 includes a refillable ice container 22 having ice paddles 42. The ice paddles 42 are located in an ice hopper 44, where the shaver blade 46 is mounted to and extends partially through an opening in the frusto-conical surface of the ice hopper 44. The ice paddles 42 are operably connected to a shaver drive motor 48 to rotate the ice paddles 42 within and with respect to the ice hopper 44. The rotation of the ice paddles 42 pushes the ice cubes or crushed ice within the ice hopper 44 against the shaver blade 46, causing the ice to be finely shaved.

The shaved ice is delivered into the mixing container 18 through the ice chute 50, where a first end 52 of the ice chute 50 is positioned adjacent to the shaver blade 46 and a second end 54 of the ice chute 50 is positioned proximal to an opening 38 in the mixing container 18.

The concentrate container holder 24 includes a housing 56 having sidewall 58 extending axially from a base surface 60 to define a chamber 62 that is sized to receive the concentrate container 80. The sidewall 58 may be shaped cylindrically or as a truncated cone to closely match the shape of the concentrate container 80. The base surface 60 may include a base opening 64 fitted with an upwardly extending hollow piercing member 66. The hollow piercing member 66 passes through the base opening 64 and extends through the base surface 60, forming an output nozzle 68 positioned proximal to the opening 38 in the mixing container 18.

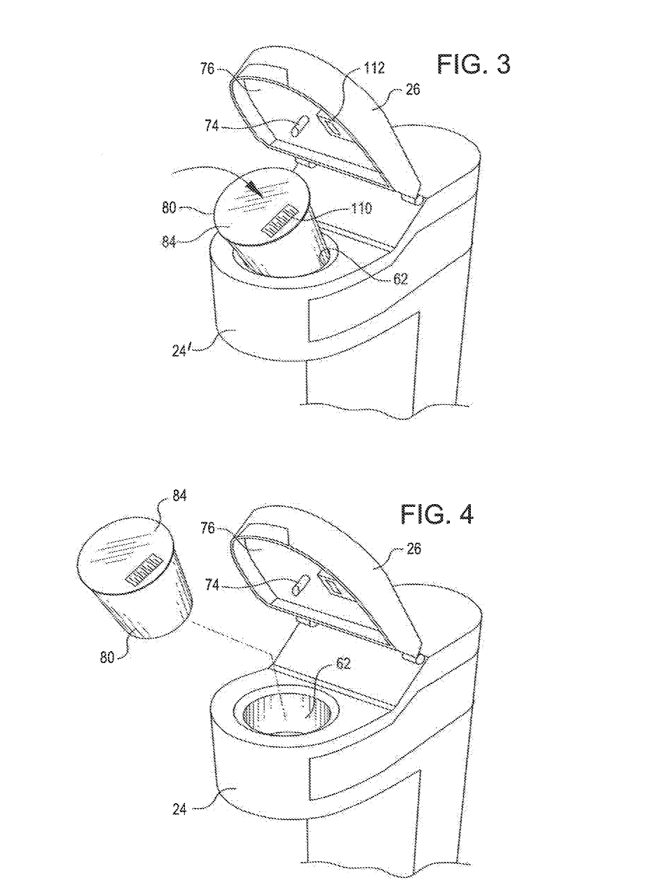

Referring also to FIGS. 3 and 4, the concentrate container holder 24 also includes a moveably lid 26. The lid 26 is in fluid communication with the reservoir 28 though tubing 70. The tubing 70 has at a first end 72 fluidly connected a hollow downwardly extending piercing member 74 fitted through an underside surface 76 of the lid 26. The lid 26 being moveable between an open position and a closed position.

In the open position, the concentrate container 80 can be positioned in the chamber 62 in the concentrate container holder 24, the bottom 82 of which is adjacent to the base surface 60 of the concentrate container holder 24. Alternatively, the concentrate container 80 can be removed from the concentrate container holder 24 after use.

In the closed position, the underside surface of the lid 76 contacts a cover portion 84 of the concentrate container 80, resulting in a simultaneous piercing of the cover and bottom portions 84, 82 of the concentrate container 80. The cover 84 of the concentrate container 80 is pierced with the lid piercing member 74 as the lid 26 is closed. Furthermore, the lid 26 forces the concentrate container 80 downward to the base surface 60 of the concentrate container holder 24, resulting in a piercing of the bottom portion 82 of the concentrate container 80 with the piecing member 66 in the base surface 60 of the concentrate container holder 24.

The reservoir 28 is removable positioned in the housing 12, and in fluid communication with the second end 86 of the tubing 70. A fluid pump 88 is positioned inline in the tubing 70, the activation of which transfers fluid 90 from the reservoir 28, through the tubing 70, to the hollow piercing member 74 in the lid 26.

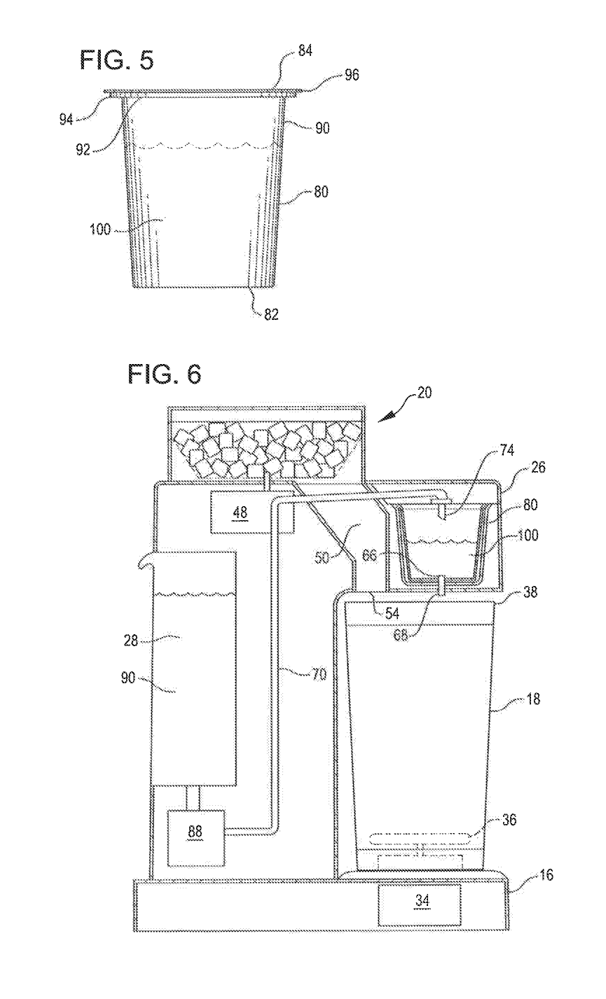

Referring to FIG. 5, the concentrate container 80 includes an impermeable pierceable base 90 having a predetermined shape such as a truncated cone with bottom portion 82 at one end and an opening 92 at an opposite end. The opening 92 can be round and have a rim/lip 94 at the opening 92, extending radially outwardly. The impermeable pierceable cover 84 which is sealed to the opening 92 in the base 90 to form a complete impermeable concentrate container 80. The cover 84 can include a rim/lip 96 which extends radially outwardly and engages, mates to, the rim 94 on the base 90. The base 90 and cover 84 may be made of a combination of polystyrene, ethylene vinyl alcohol and polyethylene.

A drink concentrate 100 can be stored in the sealed concentrate container 80, where the drink concentrate can take the form of a liquid or powder concentrate. The drink concentrate is a flavored concentrate, and can further, optionally, include nutritional elements such as vitamins, protein, mineral, and the like.

The operation the mixed beverage unit 10 is controlled by the controller, and may including a processor and memory. The controller can be preprogrammed to control the individual cycles of the units; the pump cycle, the ice shaving cycle, and the blending cycle. The controller can be programmed to operate the cycles sequentially, in an overlapping sequential manner, or in combinations.

Referring to FIG. 2, the concentrate container 80 can further include a concentrate identifier 110 which indicates the type of concentrate and resulting mixed beverage. The concentrate identifier 110 can take the form of a bar code, RFID, or other known identification systems. The lid 26 includes an electronic reader 112 for reading the concentrate identifier 110. The reader 112 is connected to the controller, where the controller includes a plurality of preprogrammed mixing routines, each corresponding to a concentrate identifier 110. The controller identified the mixing routine appropriate mixing routines, controlling the operation of the mixed beverage unit in accordance thereof.

In an exemplary method of use, the reservoir 28 is filed and ice is placed into the ice shaving unit 20. The mixing container 18 is positioned on the mixing unit 16. A user opens the lid 26 on the concentrate container holder 24 and positions a concentrate container 80 therein. The lid 26 is closed, piecing the cover 84 and bottom surface 82 of the concentrate container 80 with piercing members 66 and 74. The piercing of the concentrate container 80 creates a fluid path through the concentrate container 80, which will result in the dispensing of the fluid/concentrate mixture through the nozzle 68 into the mixing container 18 (See FIG. 6).

Using the switch 32, the controller is actuated to initiate the operation of the mixed beverage unit's 10 operational cycles, the pump cycle, the shaving cycle, and the mixing cycle. The controller operates the cycles per a preprogrammed routine.

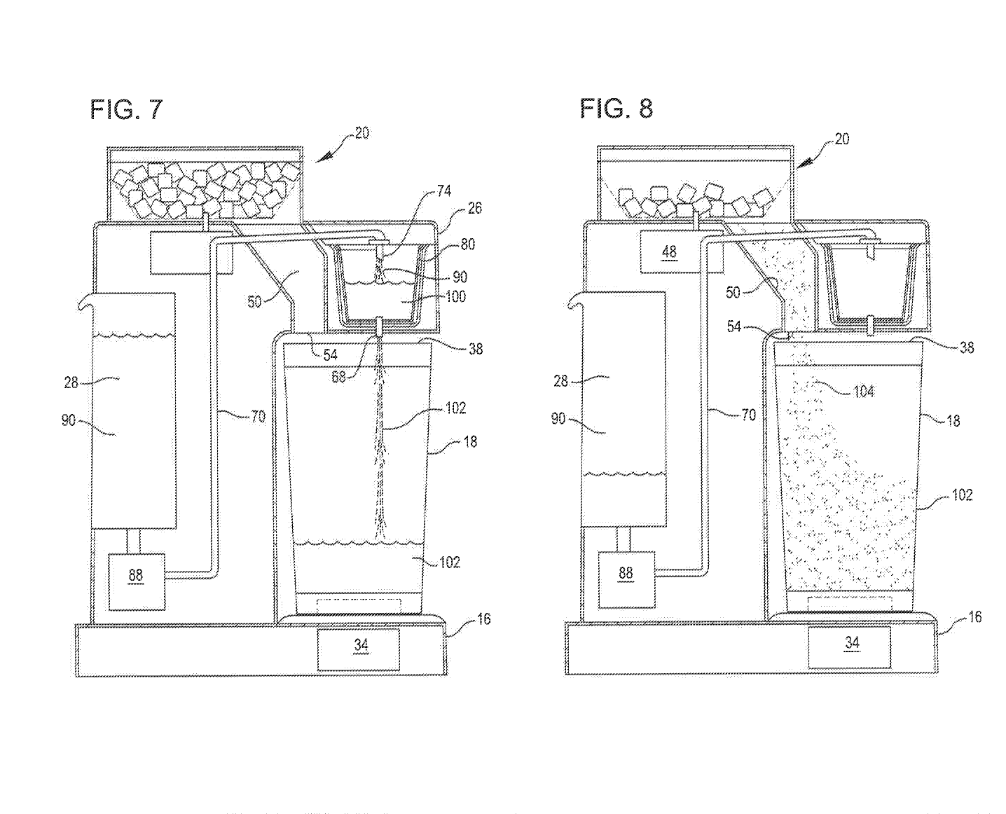

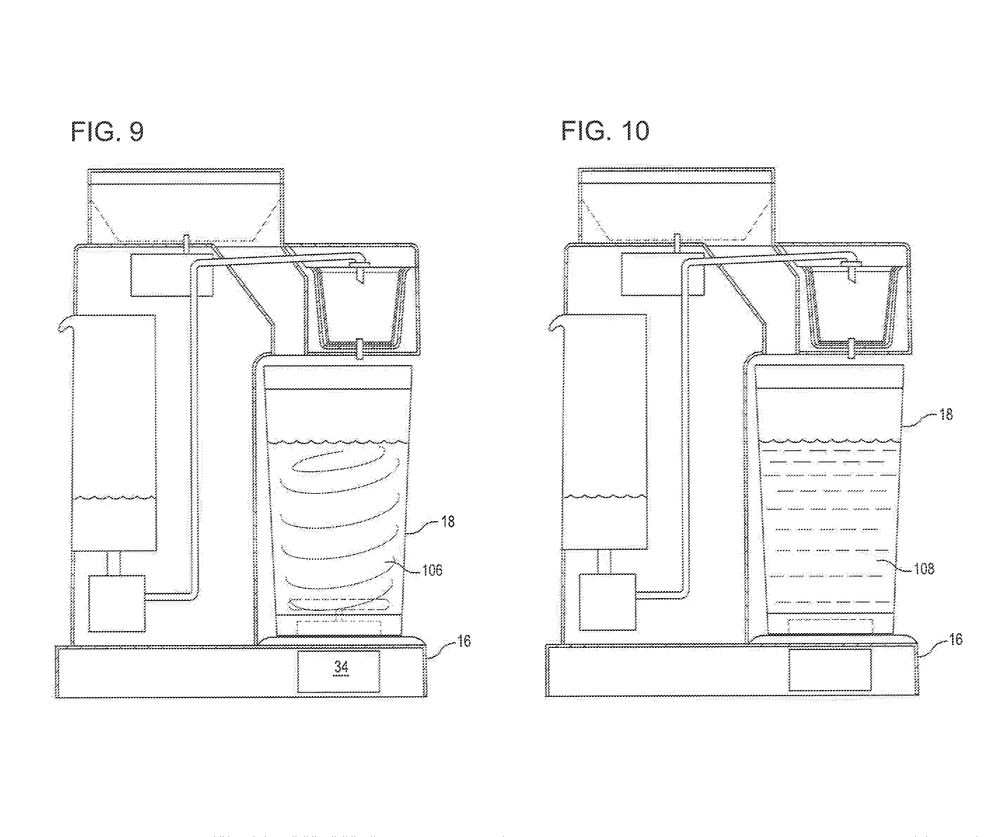

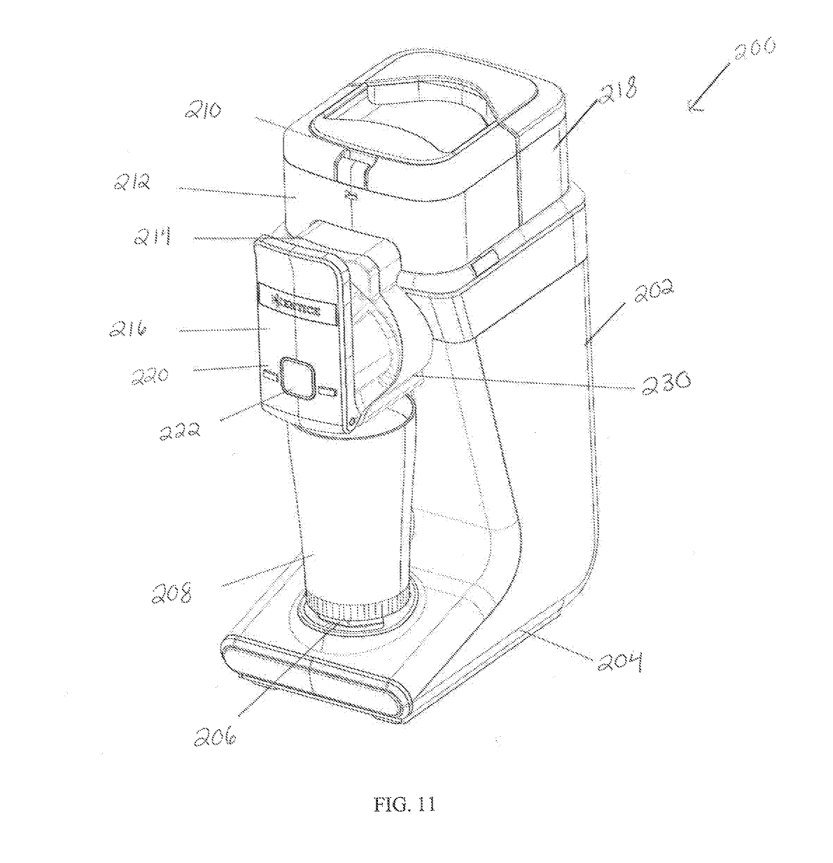

Referring to FIG. 7-10, the pump cycle is initiated. During pump cycle, the pump 88 is actuated to dispense the fluid 90 from the reservoir 28 to the concentrate container 80 through the tubing 70. The fluid 90 travels through the concentrate container 80, resulting in the evacuation of the concentrate 100 from the concentrate container 80. The fluid/concentration combination 102 is dispensed though the nozzle 68 into the mixing container 18. The pump 88 is actuated to dispense a set volume of fluid 90 into the mixing container 18, for example, 6 oz., 7 oz., 8 oz, etc. Alternatively, the pump 88 can be actuated to dispense 611 of the fluid 90 in the reservoir 28 into the mixing container 18. In such an instant, the reservoir 28 can include volumetric markings to allow the user to fill the reservoir 28 with a specified amount of fluid 90.

Upon completion of the pump cycle, the ice shaver cycle is initiated. During the ice shaving cycle the shaver drive motor 48 is activated to rotate the ice paddles 42 within and with respect to the ice hopper 44. The rotation of the ice paddles 42 pushes the ice cubes or crushed ice within the ice hopper 44 against the shaver blade 46, causing the ice to be finely shaved 104 to be dispensed into the mixing container 18. The ice shave cycle is maintained for a set time period.

Upon completion of the ice shaving cycle, the mixing cycle is initiated. The mixer drive motor 34 is activated to drive the mixing element 36, mixing the fluid, concentration, and shaved ice combination 106 in the mixing container 18. The mixing cycle is maintained for a set time period.

Upon completion the mixing cycle, the mixing container 18 including the mixed beverage 108 can be removed from the mixer unit 16. The user can optionally drink the mixed beverage 108 from the mixing container 18, or pour the mixed beverage 108 into another container such as a cup, glass, travel mug, etc.

Upon completion of the operation, the concentrate container lid 26 is opened and the concentrate container 80 removed and disposed of.

In the above example, the individual cycles were performed in a specified sequential manner. However, it is contemplated the cycles can be performed in alternative sequential manners, such, ice shaving cycle, pump cycle, and blending cycle. Alternatively, the individual cycles can be performed in an overlapping sequential manner or in combination.

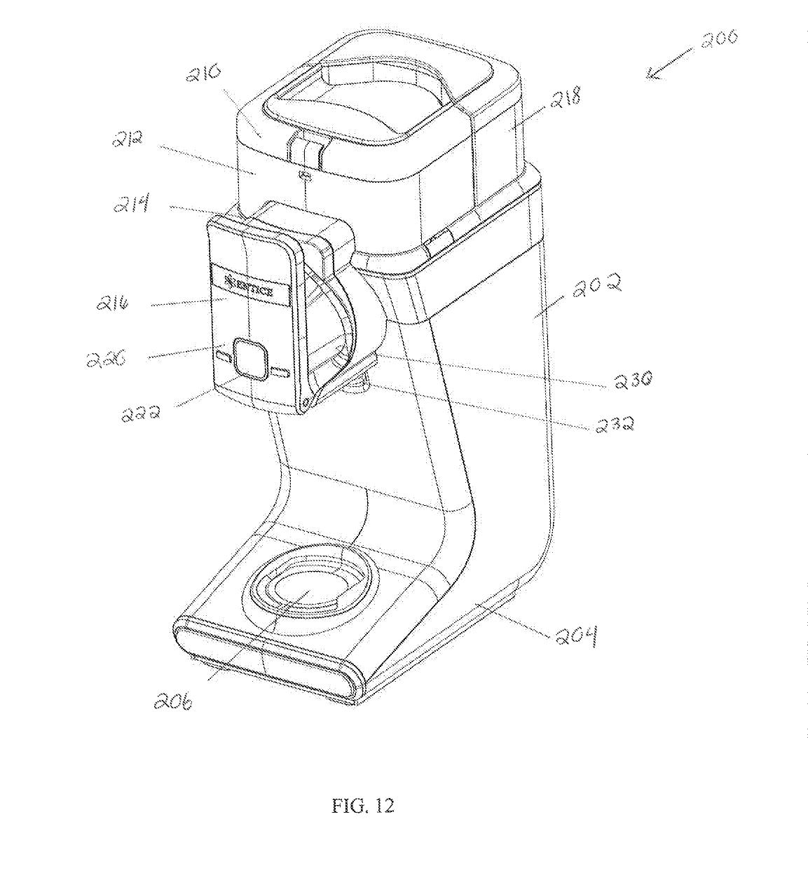

Referring to FIGS. 11-12, in another embodiment the mixed beverage maker 200 includes a housing 202 vertically connected to a base 204. The base 204 has a mixing unit 206 on which a mixing/drinking container 208 can be removably positioned. The housing 202 is vertically aligned with respect to the base 204, and includes an ice shaving unit 210 with a refillable ice container 212. A concentrate container holder 214 with a rotatable cover 216 is positioned adjacent to the ice shaving unit 210, and is in fluid communication with a reservoir 218.

A control panel 220 can be provided on a front surface of the rotatable cover 216 and includes at least one switch 222. The mixed beverage maker 200 can include a controller, having a processor and memory, configured and programmed to control the operation thereof. A power supply is connected to the mixed beverage maker 200.

Similar to the mixed beverage maker 10, and with reference to FIG. 2, the mixing unit 206 includes mixer drive motor 34 positioned in the base 14 of the housing 12. The mixer drive motor 34 can be a single direction motor for rotating a mixing element 36 in the mixing container 18. Alternatively, the mixer drive motor 34 can be a bi-directional drive motor, to selectively rotate the mixing element 36 in the mixing container 18 in either the clockwise or counter-clock wise direction in accordance with a preprogrammed mixing routine.

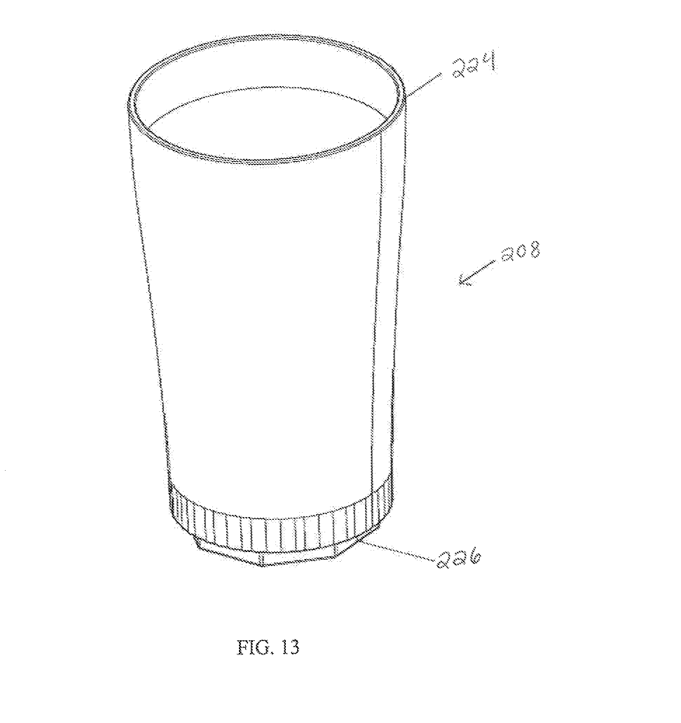

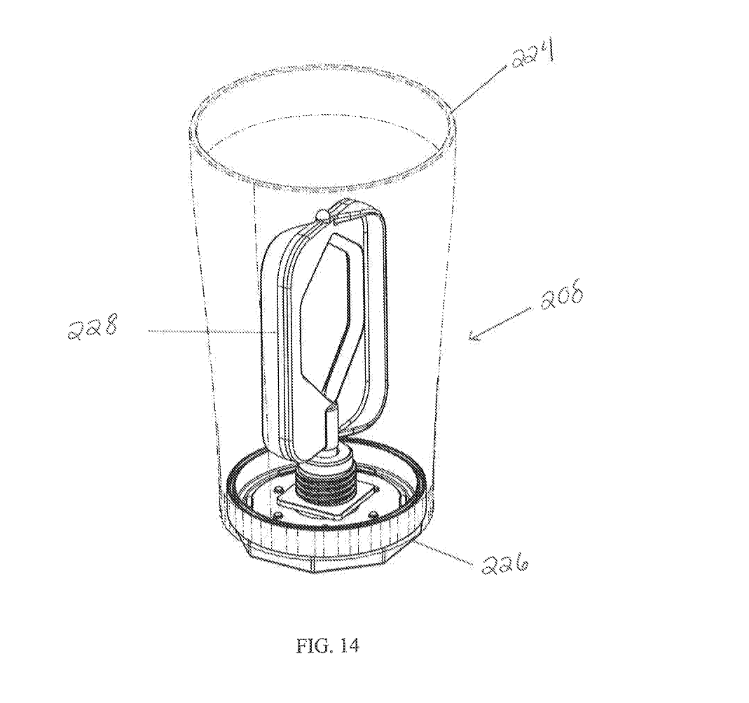

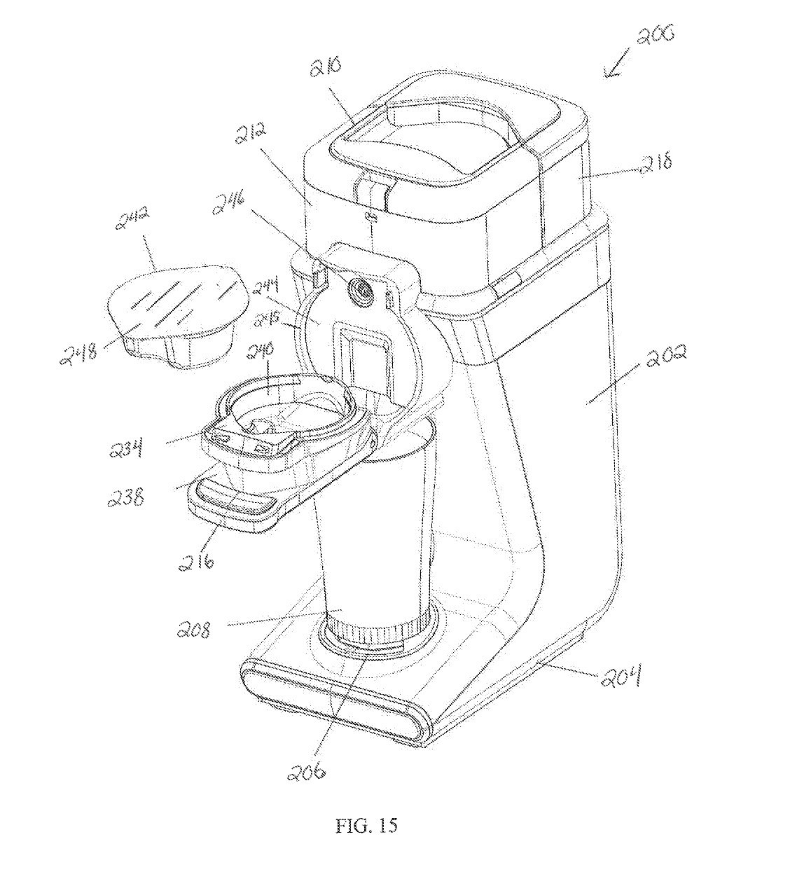

The mixing/drinking container 208 is removably positionably on the mixing unit 206. Referring to FIGS. 13-14, the mixing container 208 includes an open top end 224 and a bottom end 226 having the mixing element 228. The mixing element 228 can take the form of a whisk mixer, blender blades, mixing blades, mixing paddles, or other mixing element.

When the mixing container 208 is positioned on the mixing unit 206, the mixing element 228 is operably connected to the mixer drive motor 34. The operably connection of the mixing container 208 to the mixing unit 206 can be a physical connection, as used in standard blenders, or a magnetic connection an disclosed in U.S. Pat. No. 6,095,677 entitled Magnetic Drive Blender, the contents of which are incorporated by reference in its entirety.

The ice shaving unit 20 includes a refillable ice container 22 having ice paddles 42. The ice paddles 42 are located in an ice hopper 44, where the shaver blade 46 is mounted to and extends partially through an opening in the frusto-conical surface of the ice hopper 44. The ice paddles 42 are operably connected to a shaver drive motor 48 to rotate the ice paddles 42 within and with respect to the ice hopper 44. The rotation of the ice paddles 42 pushes the ice cubes or crushed ice within the ice hopper 44 against the shaver blade 46, causing the ice to be finely shaved.

The ice shaving unit 220 can include an adjustment mechanism for adjusting the grade of the ice. For example, the adjustment unit can adjust the position of the shaver blade 46 to adjust the grade of the ice from course to fine. Alternatively, the ice adjustment unit can control the timing of the ice shaving unit 20, to selectively increase or decrease the operating time of the ice shaving unit.

Similar to the mixed beverage maker 10, also with reference to FIGS. 2 and 1142, the shaved ice is delivered into the mixing container 208 through the ice chute 230, where a first end 52 of the ice chute 230 is positioned adjacent to the shaver blade 46 and a second end 232 of the ice chute 230 is positioned proximal to an opening 224 in the mixing container 208.

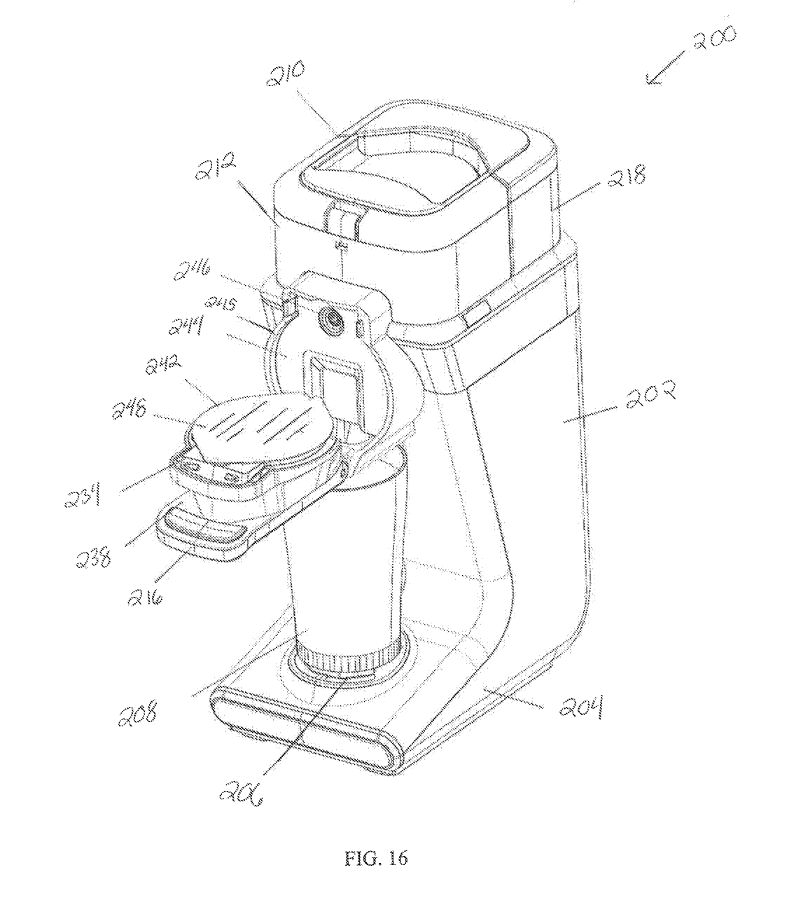

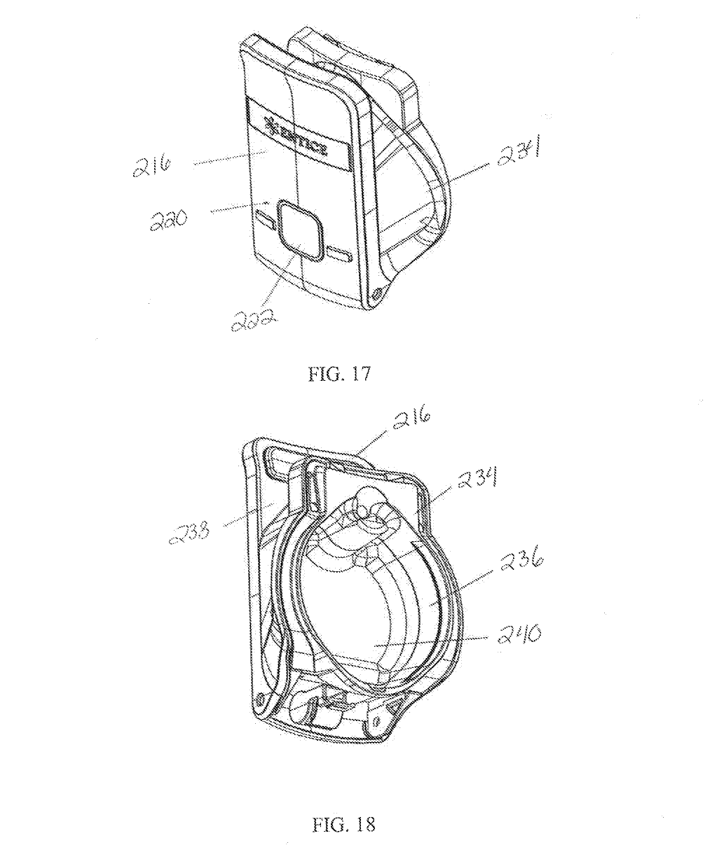

Referring to FIGS. 15-18, the concentrate container holder 214 includes a container support housing 234 having sidewall 236 extending from an inner surface 238 of the rotatable cover 216 to define a chamber 240 that is sized to receive the concentrate container 242. The sidewall 236 may be shaped to closely match the shape of the concentrate container 242.

The rotatable cover 216 of concentrate container holder 214 is rotatable between a vertical, closed position, and horizontal, open position. In the horizontal position, a concentrate container 242 can be loaded into the chamber 240. Alternatively, the concentrate container 242 can be removed from the concentrate container holder 214 after use.

In vertical position, the top surface of the container support housing 234 abuts, seals, against the mating surface 244 of the concentrate container holder 214. The mating surface 244 is surrounded by a raise perimeter edge 245, and includes a hollow piercing member 246 which is in fluid communication with the reservoir 218.

The piercing member 246 is actuatable between an extended and non-extended position. The piercing member 246 can be connect to a drive system, such as, a screw drive, pneumatic drive, cam drive, or the live to extend and retract the piercing member. In the extended position, the piercing member 246 extends to pierce the cover 248 of the concentrate container 242, creating a fluid path into the concentrate container 242.

Referring also to FIG. 2, the reservoir 218 is removable positioned in the housing 102, and in fluid communication with the tubing 70. A fluid pump 88 is positioned inline in the tubing 70, the activation of which transfers fluid 90 from the reservoir 28, through the tubing 70 and the hollow piercing member 246, into the concentrate container 242.

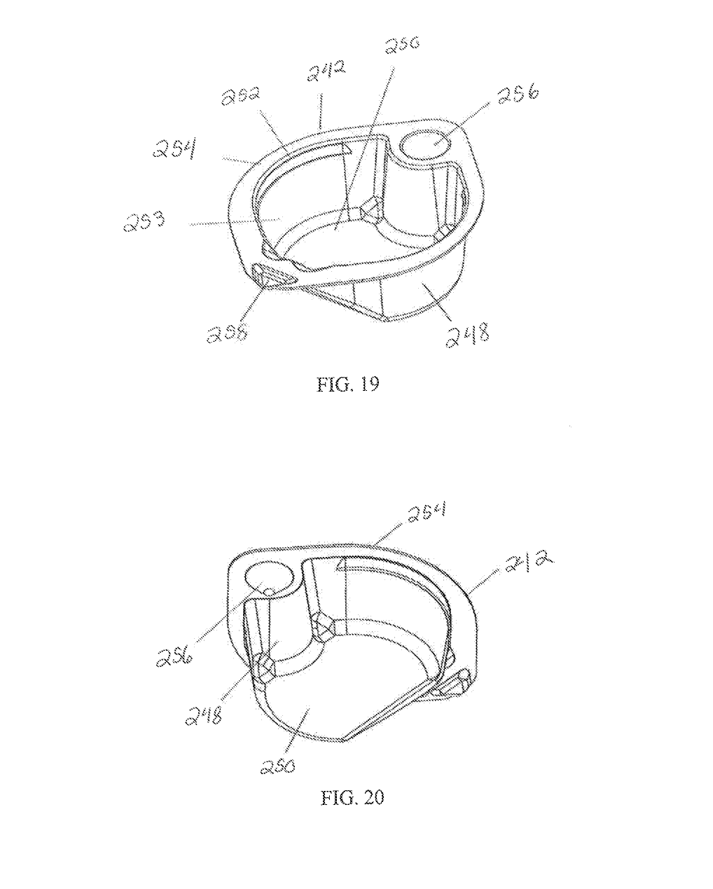

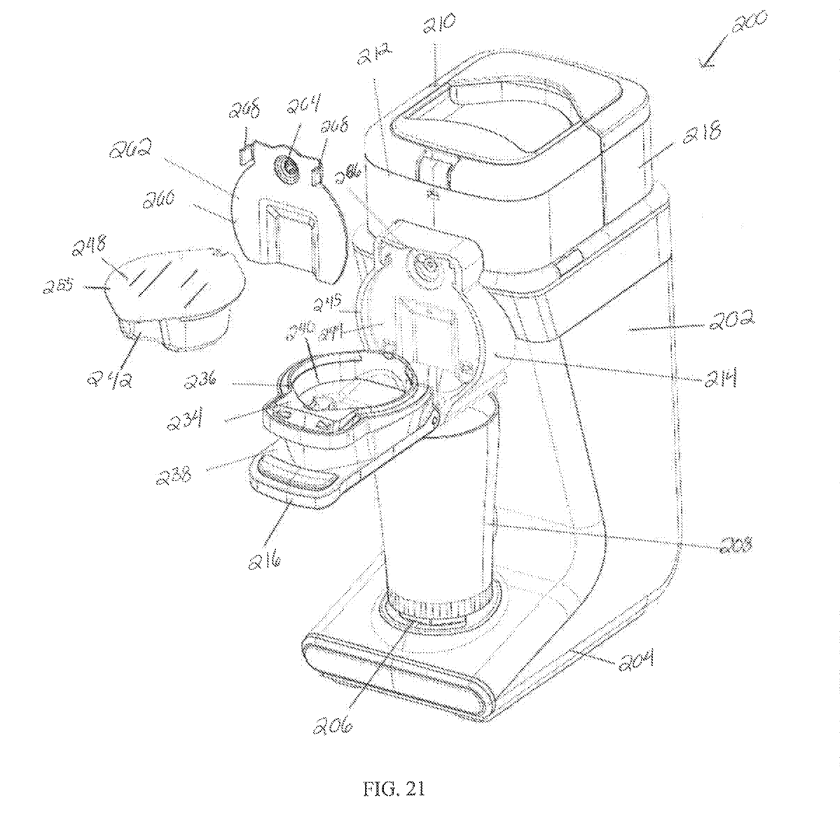

Referring to FIGS. 19-20, the concentrate container 242 includes an impermeable pierceable base 248 having a predetermined shape such as a truncated cone with bottom portion 250 at one end and an opening 252 at an opposite end, forming a concentrate chamber 253. The opening 252 can a peripheral rim/lip 254 extending radially outwardly therefrom. An impermeable pierceable cover 249 is used sealed to the rim/lip 254 of the opening 252 to form a complete impermeable concentrate container 242. The cover 249 can include a rim/lip 255 which extends radially outwardly and engages, affixes to, the rim 254 on the base 248. The base 248 and cover 249 may be made of a combination of polystyrene, ethylene vinyl alcohol and polyethylene.

The rim/lip 254 of the concentrate container 242 may further include a receiving chamber 256, separate from the concentrated chamber 253. The receiving chamber 256 is sized to receive the piercing member 246.

A drink concentrate can be stored in the sealed concentrate container 242, where the drink concentrate can take the form of a liquid or powder concentrate. The drink concentrate is a flavored concentrate, and can further, optionally, include nutritional elements such as vitamins, protein, mineral, and the like.

The operation the mixed beverage unit 200 is controlled by the controller, and may including a processor and memory. The controller can be preprogrammed to control the individual cycles of the units; the pump cycle, the ice shaving cycle, and the blending cycle. The controller can be programmed to operate the cycles sequentially, in an overlapping sequential manner, or in combinations.

In an exemplary method of use, the reservoir 213 is filed and ice is placed into the ice shaving unit 210. The mixing container 208 is positioned on the mixing unit 206. A user opens the rotatable cover 216 of the concentrate container holder 214 and positions a concentrate container 242 therein. The rotatable cover 216 is closed, sealing the concentrate container 242 against mating surface 244 of the concentrate container holder 214

Using the switch 222, the controller is actuated to initiate the operation of the mixed beverage unit's 200 operational cycles, the pump cycle, the shaving cycle, and the mixing cycle. The controller operates the cycles per a preprogrammed routine.

Upon actuation, the piecing member 246 extends to pierce the cover 249 of the concentrate container 242, where the piercing member 246 extends into the receiving chamber 256. The piercing of the concentrate container 242 creates a fluid path through the concentrate container 242, which will result in the dispensing of the fluid/concentrate mixture through an output end 258 of the concentrate container 242 into the mixing container 208.

Upon the piercing of the concentrate container 242, the pump cycle is initiated. During pump cycle, the pump 88 is actuated to dispense the fluid 90 from the reservoir 218 to the concentrate container 242 through the tubing 70. The fluid 90 travels through the concentrate container 242, resulting in the evacuation of the concentrate from the concentrate container 242.

Initially, the fluid 90 is directed into the receiving chamber 256 of the concentrate container 242. The fluid 90 pressurizes the receiving chamber 256, raising the portion of the concentrate container cover 249 between the receiving chamber 256 and the concentrate chamber 253, creating a fluid path there between. The fluid 90 entering the concentrate chamber 253 pressurizes the concentrate chamber 253 until a sufficient pressure is achieved to open the seal between the concentrate container cover 249 and the output end 258 of the concentrate container 242.

The fluid/concentration combination is dispensed though the output end 258 of the container cartridge 242 into the mixing container 208. The pump 88 is actuated to dispense a set volume of fluid 90 into the mixing container 208, for example, 6 oz., 7 oz., 8 oz. etc. Alternatively, the pump 88 can be actuated to dispense all of the fluid 90 in the reservoir 218 into the mixing container 208. In such an instant, the reservoir 218 can include volumetric markings to allow the user to fill the reservoir 218 with a specified amount of fluid 90.

Upon completion of the pump cycle, the ice shaver cycle is initiated. During the ice shaving cycle the shaver drive motor 48 is activated to rotate the ice paddles 42 within and with respect to the ice hopper 44. The rotation of the ice paddles 42 pushes the ice cubes or crushed ice within the ice hopper 44 against the shaver blade 46, causing the ice to be finely shaved 104 to be dispensed into the mixing container 18. The ice shave cycle is maintained for a set time period.

Upon completion of the ice shaving cycle, the mixing cycle is initiated. The mixer drive motor 34 is activated to drive the mixing element 228, mixing the fluid, concentration, and shaved ice combination in the mixing container 208. The mixing cycle is maintained for a set time period.

Upon completion the mixing cycle, the mixing container 208 including the mixed beverage can be removed from the mixer unit 206. The user can optionally drink the mixed beverage from the mixing container 208, or pour the mixed beverage into another container such as a cup, glass, travel mug, etc.

Upon completion of the operation, the rotatable cover 216 is opened and the concentrate container 242 removed and disposed of.

In the above example, the individual cycles were performed in a specified sequential manner. However, it is contemplated the cycles can be performed in alternative sequential manners, such, ice shaving cycle, pump cycle, and blending cycle. Alternatively, the individual cycles can be performed in an overlapping sequential manner or in combination.

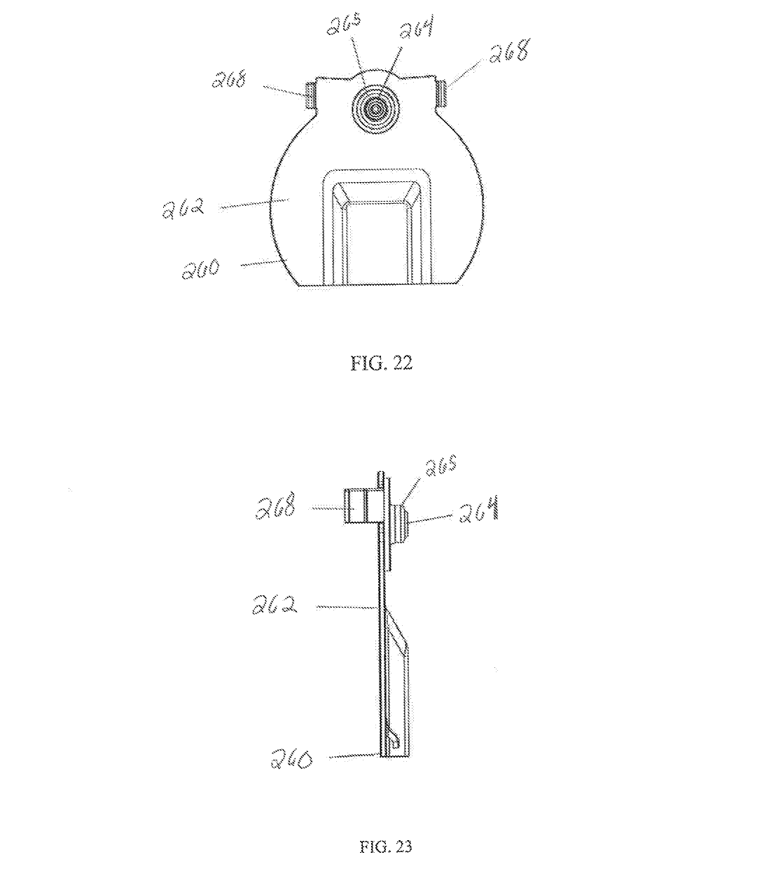

In an embodiment as shown in FIGS. 21-23, a removable fitment 260 can position against mating surface 244 of the concentrate container holder 214. The removable fitment 260 includes include a body portion 262 and a piercing member 264 positioned therein. The piercing member 264 can be positioned within a movably membrane 265, and actuatable between an extended and non-extended position. The moveable membrane 265 can be biased such that the piercing member is in the un-extended position. In the extend position, the piercing member 264 extends to pierce the cover 248 of the concentrate container 242.

The removable fitment 260 is positioned against the mating surface 244, such that in the closed position, the removable fitment 260 is interposed between the mating surface 244 and the concentrate container cover 249. The piercing member 264 of the removable fitment 260 is aligned with a hollow actuation member 266 in the mating surface 244. The actuation member 266 can take the form of a movable tube which when extended engages and moves the piercing member 264 to pierce the cover 249 of the concentrate container 242. As seal 267 can be positioned about an end portion of the actuation member 266, such that a seal is formed between the actuation member 266 and the piercing member 264 when the in the extended position. When retracted, the reverse movement of the actuation member 266 allows the piercing member 264 to move back to the unextend position.

The removable fitment 260 can further include locking tabs 268, positioned on opposing side of the fitment body 262. The locking tabs 268 can engage the raised perimeter 245 of the mating surface 244, to secure the removable fitment 260 in place.

The use of the removable fitment 260 can prevent direct contact between the actuation member 266 and the concentrate container 242, thereby preventing a direct contamination of the actuation member 266 by the drink concentrate in the concentration container 242. The removable fitment 260 is made of a washable materiel, such that, the removable fitment 26 can be removed from the concentrate container holder 214 for cleaning.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A mixed beverage maker comprising:
a mixing unit;
a housing coupled to the mixing unit and including a fluid reservoir,
an ice shaving unit positioned on the housing;
a concentrate holder vertically positioned on the housing and in fluid communication with the reservoir; and
a controller for selectively controlling the operation cycles of the mixing unit and the ice shaving unit.

2. A mixed beverage maker as set forth in claim 1, further comprising a drinking cup removably positionable on the mixing unit, the drinking cup including a first open end and a second end having a mixing element.

3. A mixed beverage maker as set forth in claim 2, wherein the mixing unit includes a drive motor selectively mechanically connectable to the mixing element in the drinking cup.

4. A mixed beverage maker as set forth in claim 2, wherein the mixing unit includes a drive motor selectively magnetically connectable to the mixing element in the drinking cup.

5. A mixed beverage maker as set forth in claim 2, where the fluid reservoir includes a pump.

6. A mixed beverage maker as set forth is claim 5, wherein the concentrate holder comprises:
a rotatable cover movable between a closed position and an open position, and including a container support housing configured to receive a concentrate container; and
a mating surface.

7. A mixed beverage maker as set forth in claim 6, wherein the mating surface includes a piercing member actuatable between an extended position and retracted position.

8. A mixed beverage maker as set forth in claim 6, wherein the mating surface includes an actuation member actuatable between an extended position and retracted position.

9. A mixed beverage maker as set forth in claim 6, further comprising a removable fitment positioned on the mating surface, and including a piercing member moveable between an extended and retracted position, wherein the actuation member engages the piercing member such that an extension of the actuation member extends piercing member.

10. A mixed beverage maker as set forth in claim 6, the ice shaving unit comprising an ice chute.

11. A mixed beverage maker as set forth in claim 10, wherein the controller is pre programmed with at least one mixing routine to automatically operate the mixing unit, ice shaving unit, and reservoir pump in accordance with the mixing routine.

12. A mixed beverage maker as set forth in claim 11, wherein the controller automatically controls a volume of fluid pumped from the fluid reservoir.

13. A mixed beverage maker as set forth in claim 12, wherein the controller automatically controls the amount of shaved ice deposited into mixing container.

14. A mixed beverage maker as set forth in claim 13, wherein the controller automatically controls an operational time of the mixing unit.

15. A mixed drink maker comprising:
a base including a mixing unit having a drive motor;
a mixing container removable positionable on the mixing unit, the mixing container include a first open end and a second end having a mixing element, wherein the mixing element is selectively connectable to the drive motor;
a housing positioned on the base and including a fluid reservoir, the fluid reservoir having a pump;
an ice shaving unit positioned on the housing, opposite the base, the ice shaving unit including an ice chute positioned proximal to the open end of the mixing container;
a concentrate holder vertically positioned on the housing and including a rotatable cover and a mating surface, the mating surface having a piercing member actuatable between an extended position and retracted position; and
a controller operably connected to the mixing unit, the ice shaving unit, and the reservoir pump, the controller selectively controlling the operation cycles of the mixing unit, the ice shaving unit, and the reservoir pump

16. A mixed beverage maker as set forth in claim 15, wherein the rotatable cover includes a container support housing configured to receive a concentrate container

17. A mixed beverage maker as set forth in claim 16, further comprising a drive motor connected to the piercing member, wherein an activation of the drive motor can move the piercing member between the extended and retracted positions.

18. A mixed drink maker comprising:
a base including a mixing unit having a drive motor;
a mixing container removable positionable on the mixing unit, the mixing container include a first open end and a second end having a mixing element, wherein the mixing element is selectively connectable to the drive motor;
a housing positioned on the base and including a fluid reservoir, the fluid reservoir having a pump;
an ice shaving unit positioned on the housing, opposite the base, the ice shaving unit including an ice chute positioned proximal to the open end of the mixing container;
a concentrate holder vertically positioned on the housing and including a rotatable cover and a mating surface, the mating surface having a actuation member actuatable between an extended position and retracted position;
a removable fitment positioned on the mating surface, and including a piercing member moveable between an extended and retracted position, wherein the actuation member engages the piercing member such that an extension of the actuation member extends piercing member; and
a controller operably connected to the mixing unit, the ice shaving unit, and the reservoir pump, the controller selectively controlling the operation cycles of the mixing unit, the ice shaving unit, and the reservoir pump

19. A mixed beverage maker as set forth in claim 18, wherein the rotatable cover includes a container support housing configured to receive a concentrate container

20. A mixed beverage maker as set forth in claim 18, further comprising a drive motor connected to the actuation member, wherein an activation of the drive motor can move the actuation member between the extended and retracted positions.
